(19) United States
(12) Patent Application Publication
(10) Pub. No.: US 2021/0383989 A1
(43) Pub. Date: Dec. 9, 2021

(54) PARAMETER ADJUSTMENTS TO HUMAN INTERFACE DEVICES

(71) Applicant: Hewlett-Packard Development Company, L.P., Spring, TX (US)

(72) Inventors: Syed S. Azam, Spring, TX (US); Dimitre Mehandjiysky, Spring, TX (US); Alexander Williams, Spring, TX (US); Lee Lim See, Taipei (TW); Szu-Yi Chai, Taipei (TW)

(73) Assignee: Hewlett-Packard Development Company, L.P., Spring, TX (US)

(21) Appl. No.: 17/042,977

(22) PCT Filed: Feb. 28, 2019
(86) PCT No.: PCT/US2019/020040

§ 371 Date: Sep. 29, 2020

(51) Int. Cl. H01H 13/85; G06F 3/02; H01H 13/705; H01H 13/703; H01H 13/704

(52) U.S. Cl. CPC H01H 13/85; G06F 3/0202; H01H 13/704; H01H 13/703; H01H 13/705

(57) ABSTRACT

In an example implementation according to aspects of the present disclosure, a method may include determining whether a user profile associated with a user of a computing device is available for a human interface device (HID) of the computing device, and, upon determining that the user profile is available, adjusting a parameter of the HID according to a setting found in the user profile.

### BACKGROUND

Human interface devices (HIDs) such as a keyboard, mouse, audio input/output device, display, or virtual reality head-mounted display, may be associated with hosts, such as a computing device, to be used by a user of the computing device, for example, to take input from the user and/or give output to them. While using HIDs with computing devices, users may have their own personal preferences in how the HIDs are operated. For example, with regards to keyboards, each user may have a preference in the amount of sound that is generated when pressing a key. In addition, the user may have a preference on the impact feedback felt by the user upon pressing a key on the keyboard. Such preferences may impact the keyboard (or other HID) that is ultimately purchased by a user. In addition, the user experience may be impacted if the user is left with an HID having parameters that do not meet the preferences of the user.

### BRIEF DESCRIPTION OF THE DRAWINGS

FIG. 1 illustrates an HID for adjusting a parameter of the HID, for example, according to user preference;

FIG. 2 illustrates a method for adjusting parameters of the HID according to user preference, according to an example; and

FIG. 3 is a flow diagram in accordance with an example of the present disclosure.

### DETAILED DESCRIPTION

Examples disclosed herein provide the ability to dynamically adjust parameters of an HID according to the user of a computing device operating the HID. As will be further described, if a user profile associated with the user is identified, a parameter of the HID may be adjusted according to a setting found in the user profile. In addition, further adjustments may be made to parameters of the HID, based on interactions by the user with the HID, for example, while using the HID to operate the computing device. As a result of dynamically making adjustments to parameters of an HID, each user of the HID may have a customized user experience, according to their personal preferences. For example, with regards to keyboards, the amount of sound that is generated when pressing a key or the impact feedback felt may be adjusted accordingly to each user utilizing the keyboard.

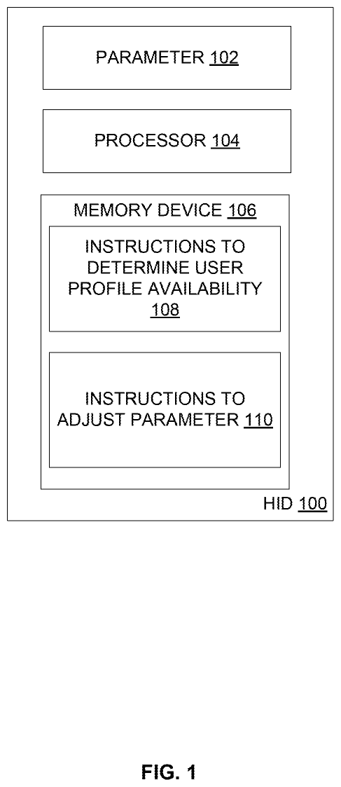

With reference to the figures, FIG. 1 illustrates an HID 100 for adjusting a parameter of the HID 100, for example, according to user preference, thereby, enhancing the user experience. As will be further described, in addition to making adjustments, for example, when a user profile associated with a user of a computing device is available for the HID 100 while coupled to the computing device, adjustments may be made dynamically as well, while the user simultaneously interacts with the HID 100. As mentioned above, although HIDs may refer to various devices, such as a mouse or keyboard, reference may be made to the keyboard specifically, for example, with regards to the amount of sound that is generated when pressing a key, or the impact feedback felt while utilizing the keyboard. However, examples of the present disclosure may also apply to other HIDs including buttons in different form factors, where each user may be able to customize their experience.

The HID 100 depicts a processor 104 and a memory device 106 and, as an example of the HID 100 performing its operations, the memory device 106 may include instructions 108-110 that are executable by the processor 104. Thus, memory device 106 can be said to store program instructions that, when executed by processor 104, implement the components of the HID 100. The executable program instructions stored in the memory device 106 include, as an example, instructions to determine user profile availability (108) and instructions to adjust a parameter (110).

Instructions to determine user profile availability (108) represent program instructions that when executed by the processor 104 cause the HID 100 to determine whether a user profile associated with a user of a computing device is available for the HID 100, for example, while coupled to the computing device. As an example, the HID 100 may be wirelessly coupled to the computing device, for example, via Bluetooth, coupled via a wired connection, for example, via USB, or integrated with the computing device. If a user profile associated with the user is available for the HID 100, settings may be found in the user profile for making adjustments to parameters of the HID 100, as will be further described. As an example, availability of the user profile may be determined once a user logs into the computing device that the HID 100 is coupled to. However, availability of the user profile may also be determined separate from the login event on the computing device. For example, the HID 100 may include a separate authentication process for authenticating a user to utilize the HID 100 while interacting with the computing device (e.g., fingerprint or passcode entry). As an example, determination of whether a user profile is available may be made upon initial setup of the HID 100 with the computing device, or each time a user logs into the computing device.

Instructions to adjust parameter (110) represent program instructions that when executed by the processor 104 cause the HID 100, upon determining that the user profile is available, to adjust a parameter of the HID 100 according to a setting found in the user profile. However, if a user profile is not available, parameters of the HID 100 may be adjusted according to default settings. Various parameters of the HID 100 may be adjusted in order to improve the user experience for a user. For example, the parameters may relate to software parameters, while using the HID 100 to interact with the computing device. As an example, the parameters may relate to physical parameters that can alter the feel or experience of the HID 100 while it is being used by the user. With regards to keyboards, adjustments to physical parameters may affect the amount of sound that is generated when pressing a key, or the impact feedback felt while utilizing the keyboard. Examples of such adjustments may include adjusting an amount of air pressure in a sound dampening layer of the HID 100, adjusting a force required to actuate buttons of the HID 100, and adjusting a level of a base layer of the HID 100 with respect to the buttons.

As an example, an air pump system may be integrated into a keyboard, in order to control the inflation of an air inflation membrane (e.g., sound dampening layer) placed underneath the keys of the keyboard. As a result, the sound emitted from the actuation of keys from the keyboard may be absorbed by the inflation of the sound dampening material layer surrounding the base of the keyboard keys. As an example, the membrane is made out of sound dampening material, so that sound waves emitted from the actuation of a keyboard key are absorbed by the membrane. Therefore, the emittance of the sound to the user of the keyboard may be reduced significantly as the membrane absorbs the sound of the actuation. As an example, there will be preset levels of inflation for the membrane, at certain increments of pounds per square inch (psi). As an example, a pressure gauge monitor on the air output to the membrane will be able to provide programmatically the current psi of the keyboard membrane to the user. As a result, if a user profile is available for a user currently using the keyboard (e.g., HID 100), the sound dampening layer may be inflated (or deflated) to the appropriate level preferred by the user, as indicated by a setting found in the user profile.

Additionally, by inflating the sound dampening material layer, a user may control the impact feedback of a keypress since it may not take a full keyboard keypress to trigger a typing event. Each user may have their own personal preference for a key press feeling (e.g., deeper keypress or softer touch). As an example, the air membrane will be able to inflate to different set heights so that the “base” of the keyboard is raised according to a user preference, so that a user can feel that they have pressed the key down as far as it will go. As mentioned above, if a user profile is available for a user currently using the keyboard (e.g., HID 100), the sound dampening layer may be inflated (or deflated) to provide the impact feedback preferred by the user. As an example, the setting found in the user profile may include a desired feedback response while the user is to interact with the HID 100.

As an example, rather than relying on the sound dampening layer to control impact feedback, as each key press may be controlled via spring tension of each key cap, electrically controlling the spring torque may control the key force needed to suppress the key. As a result, if a user profile is available for a user currently using the keyboard (e.g., HID 100), the spring torque of each key may be adjusted to provide the impact feedback preferred by the user. In addition, a level of a base layer of the keyboard with respect to the keys may be mechanically controlled, in order to create the travel distance desired, creating the keypress feel desired by a user.

As an example, adjustments may be made to the parameter of the HID 100 according to an interaction by the user with the HID 100. For example, adjustments may be made dynamically, while the user simultaneously interacts with the HID 100. As an example, the noise generated while using the HID 100 may be controlled by making adjustments dynamically. The adjustment made according to the interaction by the user with the HID may vary based on a decibel level of the sound created by the interaction. The decibel level may be measured by the HID 100 itself or, for example, via a microphone of the computing device.

As an example, if the parameter being adjusted is the amount of air pressure in the sound dampening layer, and if the decibel level is above a threshold value, the adjustment may include increasing the amount of air pressure in the sound dampening layer, thereby increasing the ability for the sound dampening layer to absorb more of the sound generated while using the HID 100. However, if the decibel level is below the threshold value, the adjustment may include decreasing the amount of air pressure in the sound dampening layer. Thereby, the noise preference by a particular user of the HID 100 may be dynamically controlled, for example, by varying the threshold value according to user preference.

As an example, if the parameter being adjusted is the level of the base layer of the HID 100, and if the decibel level is above a threshold value, the adjustment may include raising the level of the base layer of the HID 100 with respect to the buttons, thereby reducing the impact feedback and the noise generated. However, if the decibel level is below the threshold value, the adjustment may include lowering the level of the base layer of the HID with respect to the buttons.

In addition to making adjustments according to user preference, adjustments to parameters of the HID 100 may be made, for example, according to a time of the day (e.g., during working hours versus outside of working hours). If, for example, a user is using the HID 100 during the nighttime, parameters may be adjusted on the HID 100 in order to reduce any noise generated. For example, the sound dampening layer may be inflated to absorb more noise, or the base layer may be raised, as described above, in order to reduce impact feedback.

Memory device 106 represents generally any number of memory components capable of storing instructions that can be executed by processor 104. Memory device 106 is non-transitory in the sense that it does not encompass a transitory signal but instead is made up of at least one memory component configured to store the relevant instructions. As a result, the memory device 106 may be a non-transitory computer-readable storage medium. Memory device 106 may be implemented in a single device or distributed across devices. Likewise, processor 104 represents any number of processors capable of executing instructions stored by memory device 106. Processor 104 may be integrated in a single device or distributed across devices. Further, memory device 106 may be fully or partially integrated in the same device as processor 104, or it may be separate but accessible to that device and processor 104.

In one example, the program instructions 108-110 can be part of an installation package that when installed can be executed by processor 104 to implement the components of the HID 100. In this case, memory device 106 may be a portable medium such as a CD, DVD, or flash drive or a memory maintained by a server from which the installation package can be downloaded and installed. In another example, the program instructions may be part of an application or applications already installed. Here, memory device 106 can include integrated memory such as a hard drive, solid state drive, or the like.

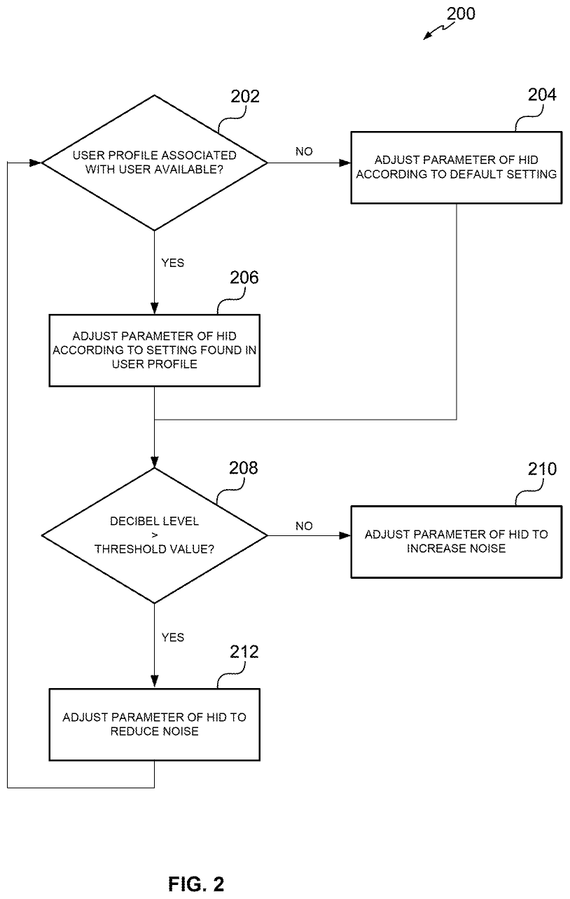

FIG. 2 illustrates a method 200, for example, at an HID, for adjusting parameters of the HID according to user preference, according to an example. In discussing FIG. 2, reference may be made to the example HID 100 illustrated in FIG. 1. Such reference is made to provide contextual examples and not to limit the manner in which method 200 depicted by FIG. 2 may be implemented.

Method 200 begins at 202, where the HID determines whether a user profile associated with a user is available for the HID. As an example, availability of the user profile may be determined once a user logs into a computing device that the HID is coupled to. However, availability of the user profile may also be determined separate from the login event on the computing device. For example, the HID may include a separate authentication process for authenticating a user to utilize the HID while interacting with the computing device (e.g., fingerprint or passcode entry).

At 204, if a user profile is not available, parameters of the HID may be adjusted according to default settings (e.g., manufacturer settings). However, at 206, if a user profile is available, parameters of the HID are adjusted according to a setting found in the user profile. As an example, the parameters may relate to physical parameters that can alter the feel or experience of the HID while it is being used by the user. With regards to keyboards, adjustments to physical parameters may affect the amount of sound that is generated when pressing a key, or the impact feedback felt while utilizing the keyboard. Examples of such adjustments may include adjusting an amount of air pressure in a sound dampening layer of the HID, adjusting a force required to actuate buttons of the HID, and adjusting a level of a base layer of the HID with respect to the buttons.

In addition to adjusting parameters, for example, when the HID is initially set up for a user, or every time the user logs into a computing device that the HID is coupled to, adjustments may be made to the parameters of the HID as well while the user is using the HID. For example, if the noise generated while using the HID changes, adjustments may be made dynamically, for example, to control the noise. The adjustment made according to the interaction by the user with the HID may vary based on a decibel level of the sound created by the interaction. The decibel level may be measured by the HID itself or, for example, via a microphone of the computing device.

At 208, it is determined whether the decibel level measured is greater than a threshold value. At 212, if the decibel level is greater than the threshold value, parameters of the HID may be adjusted to reduce noise. For example, if the parameter being adjusted is the amount of air pressure in the sound dampening layer, as described above, the adjustment may include increasing the amount of air pressure in the sound dampening layer, thereby increasing the ability for the sound dampening layer to absorb more of the sound generated while using the HID. As an example, if the parameter being adjusted is the level of the base layer of the HID, the adjustment may include raising the level of the base layer of the HID with respect to the buttons, thereby reducing the impact feedback and the noise generated.

At 210, if the decibel level is less than the threshold value, parameters of the HID may be adjusted, for example, to increase noise. For example, if the parameter being adjusted is the amount of air pressure in the sound dampening layer, the adjustment may include decreasing the amount of air pressure in the sound dampening layer. As an example, if the parameter being adjusted is the level of the base layer of the HID, the adjustment may include lowering the level of the base layer of the HID with respect to the buttons.

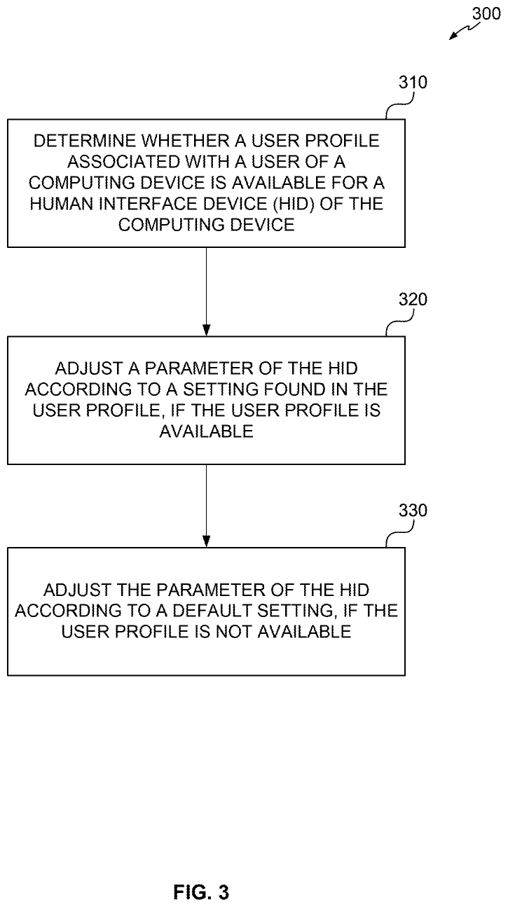

FIG. 3 is a flow diagram 300 of steps taken by an HID to implement a method for adjusting parameters according to user preference, according to an example. Although the flow diagram of FIG. 3 shows a specific order of execution, the order of execution may differ from that which is depicted. For example, the order of execution of two or more blocks or arrows may be scrambled relative to the order shown. Also, two or more blocks shown in succession may be executed concurrently or with partial concurrence. All such variations are within the scope of the present disclosure.

At 310, the HID determines whether a user profile associated with a user of a computing device is available for the HID while it is coupled the computing device. As an example, availability of the user profile may be determined once a user logs into the computing device that the HID is coupled to. However, availability of the user profile may also be determined separate from the login event on the computing device. For example, the HID may include a separate authentication process for authenticating a user to utilize the HID while interacting with the computing device (e.g., fingerprint or passcode entry).

At 320, if the user profile is available, the HID adjusts a parameter of the HID according to a setting found in the user profile. As an example, the parameters may relate to physical parameters that can alter the feel or experience of the HID while it is being used by the user, as described above. At 330, if the user profile is not available, the HID adjusts the parameter of the HID according to a default setting (e.g., manufacturer setting).

It should be understood that examples described herein below may include various components and features. It should also be understood that, in the following description, numerous specific details are set forth to provide a thorough understanding of the examples. However, it should be understood that the examples may be practiced without limitations to these specific details. In some instances, well known methods and structures may not be described in detail to avoid obscuring the description of the examples. Also, the examples may be used in combination with each other.

Reference in the specification to “an example” or similar language means that a particular feature, structure, or characteristic described in connection with the example is included in at least one example, but not necessarily in other examples. The various instances of the phrase “in one example” or similar phrases in various places in the specification are not necessarily all referring to the same example.

It should be understood that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

What is claimed is:

1. A method comprising:
determining whether a user profile associated with a user of a computing device is available for a human interface device (HID) of the computing device; and
upon determining that the user profile is available, adjusting a parameter of the HID according to a setting found in the user profile.

2. The method of claim 1, wherein upon determining that the user profile is not available, adjusting the parameter of the HID according to a default setting.

3. The method of claim 1, wherein adjusting the parameter comprises:
adjusting an amount of air pressure in a sound dampening layer of the HID,
adjusting a force required to actuate buttons of the HID, and
adjusting a level of a base layer of the HID with respect to the buttons.

4. The method of claim 3, comprising:
making an adjustment to the parameter of the HID according to an interaction by the user with the HID.

5. The method of claim 4, wherein the adjustment made according to the interaction by the user with the HID varies based on a decibel level of the sound created by the interaction.

6. The method of claim 5, wherein:
if the decibel level is above a threshold value, the adjustment comprises increasing the amount of air pressure in the sound dampening layer, and
if the decibel level is below the threshold value, the adjustment comprises decreasing the amount of air pressure in the sound dampening layer.

7. The method of claim 5, wherein:
if the decibel level is above a threshold value, the adjustment comprises raising the level of the base layer of the HID with respect to the buttons, and
if the decibel level is below the threshold value, the adjustment comprises lowering the level of the base layer of the HID with respect to the buttons.

8. The method of claim 1, wherein the setting found in the user profile comprises a desired feedback response while the user is to interact with the HID.

9. The method of claim 1, comprising:
making an adjustment to the parameter of the HID according to a time of day.

10. A human interface device (HID) comprising:
an adjustable parameter to physically alter characteristics of the HID; and
a processor to:
determine whether a user profile associated with a user of a computing device is available for the HID while coupled to the computing device; and
upon determining that the user profile is available, adjust the parameter of the HID according to a setting found in the user profile.

11. The HID of claim 10, wherein the processor to adjust the parameter comprises:
adjusting an amount of air pressure in a sound dampening layer of the HID,
adjusting a force required to actuate buttons of the HID, and
adjusting a level of a base layer of the HID with respect to the buttons.

12. The HID of claim 10, wherein the processor is to make an adjustment to the parameter of the HID according to an interaction by the user with the HID.

13. A non-transitory computer-readable storage medium comprising program instructions which, when executed by a processor, cause the processor to:
determine whether a user profile associated with a user is available for a human interface device (HID);
upon determining that the user profile is available, adjust a parameter of the HID according to a setting found in the user profile; and
make further adjustments to the parameter of the HID according to an interaction by the user with the HID.

14. The non-transitory computer-readable storage medium of claim 13, wherein upon determining that the user profile is not available, comprising program instructions to cause the processor to adjust the parameter of the HID according to a default setting.

15. The non-transitory computer-readable storage medium of claim 13, comprising program instructions to cause the processor to make an adjustment to the parameter of the HID according to a time of day.
